(19) United States
(12) Patent Application Publication
(10) Pub. No.: US 2014/0042305 A1
(43) Pub. Date: Feb. 13, 2014

(54) OPTICAL PACKAGE MODULE

(71) Applicant: SIGURD MICROELECTRONICS CORP., SHIN-CHU (TW)

(72) Inventor: CHIU-WEI LIU, SHIN-CHU (TW)

(73) Assignee: SIGURD MICROELECTRONICS CORP., SHIN-CHU (TW)

(21) Appl. No.: 13/953,911

(22) Filed: Jul. 30, 2013

(30) Foreign Application Priority Data
Aug. 10, 2012 (TW) 101215491

(51) Int. Cl. G01V 8/12

(52) U.S. Cl. CPC G01V 8/12
USPC 250/216

(57) ABSTRACT

The present invention provides an optical package module, which comprises a substrate, a light emitting element, a first molding compound, a second molding compound, a light sensing element, and a cap. The light emitting element and the light sensing element are disposed on the substrate, and the first molding compound and the second molding compound are respectively molded upon the light sensing element and the light emitting element. The first molding compound comprises a first optical structure corresponding to the light sensing element, and the second molding compound comprises a second optical structure corresponding to the light emitting element. By designing the first and second optical structure of the optical package module, it achieves the purposes of improving light emitting and sensing efficiency of the present invention.

### BACKGROUND OF THE INVENTION

1. Field of the Invention

The present invention relates to an optical package module, and more particularly to an optical package module which can be utilized to increase both the light emitting and sensing efficiency.

2. Description of the Prior Art

Generally speaking, portable electronic devices nowadays, for example: smart phones, are usually equipped with at least one proximity optical sensing module in order to achieve the objectives of palm rejection and/or less power consumption. In other words, when the above-mentioned electronic device (i.e. smart phones) gets closed to a surface of a certain object, for example, a user's face, then the portable electronic device senses the surface and accordingly shuts down part of its power supply to decrease power consumption and/or to perform palm rejection. To be more specific, how the portable electronic device works is related to a light emitting integrated chip (IC) which is utilized to emit a light source. Then, the light being emitted will be refracted by an interactive media (i.e. the user's face) and be projected to its nearby light sensing integrated chip (IC). After receiving the light, the light sensing IC can transform the light signal into electrical signals for further process.

For example, prior arts have disclosed a kind of molding structure, which comprises a light sensing chip to be configured upon a lead frame and to form an active area and a non-active area thereof. The non-active area is disposed around the active area; a plurality of wires are connected to the light sensing chip and the lead frame; a cap package layer is opaque, disposed between the non-active area and the lead frame, and covers the non-active area, the plurality of wires and a portion of the lead frame so as to form an opening area which is corresponding to the active area.

However, it should be noticed that by employing the above mentioned structure proposed in the prior arts, since the active area of the light sensing chip is open-ended and not covered by any optical instruments, the light sensing efficiency thereof is not good enough. Besides, a great number of pollutants will be accumulated due to the open-ended area, thereby affecting its light sensing performance as well. Moreover, since the light sensing chip is exposed to air and not covered, it will be destroyed and damaged easily, thereby shortening its life time.

On account of above, it should be obvious that there is indeed an urgent need for the professionals in the field for a new package module to be developed that can effectively solve those above mentioned problem occurring in the prior design.

### SUMMARY OF THE INVENTION

In order to overcome the above-mentioned disadvantages, one major objective in accordance with the present invention is provided for a novel optical package module. By employing the optical package module of the present invention, it can be utilized so as to increase both the light emitting and sensing efficiency.

For achieving the above mentioned objectives, the present invention provides an optical package module, which comprises at least a substrate, a light emitting element, a first molding compound, a second molding compound, a light sensing element, and a cap. The light emitting element and the light sensing element are disposed on the substrate, and the first molding compound and the second molding compound are respectively disposed upon the light sensing element and the light emitting element. The first molding compound comprises a first optical structure corresponding to the light sensing element, and the second molding compound comprises a second optical structure corresponding to the light emitting element. By designing the first and second optical structure of the optical package module, it achieves the purposes of improving light emitting and sensing efficiency of the present invention.

According to one embodiment of the present invention, the first optical structure can be a convex lens or a concave lens. Alternatively, the second optical structure may also be a convex lens or a concave lens.

According to one embodiment of the present invention, the cap may further comprise a protruding part which extends into a gap, and the gap is formed between the first molding compound and the second molding compound.

According to one embodiment of the present invention, the substrate can be a printed circuit board (PCB) or a lead frame.

According to one embodiment of the present invention, the first molding compound and the second molding compound can be made of transparent material, for example, transparent Epoxide Resin while the cap is made of opaque material, such as opaque Epoxide Resin.

According to one embodiment of the present invention, the optical package module may further comprise a plurality of electrical connections disposed on the substrate such that the light emitting element and the light sensing element can be electrically connected to the plurality of electrical connections via at least one wire.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 shows a schematic drawing of an optical package module in accordance with a first embodiment of the present invention.

FIG. 2 shows another schematic drawing of an optical package module in accordance with a first embodiment of the present invention.

FIG. 3 shows a schematic drawing of an optical package module in accordance with a second embodiment of the present invention.

FIG. 4 shows a schematic drawing of an optical package module in accordance with a third embodiment of the present invention.

FIG. 5 shows a schematic drawing of an optical package module in accordance with a fourth embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The embodiments described below are illustrated to demonstrate the technical contents and characteristics of the present invention and to enable the persons skilled in the art to understand, make, and use the present invention. However, it shall be noticed that, it is not intended to limit the scope of the present invention. Therefore, any equivalent modification or variation according to the spirit of the present invention is to be also included within the scope of the present invention.

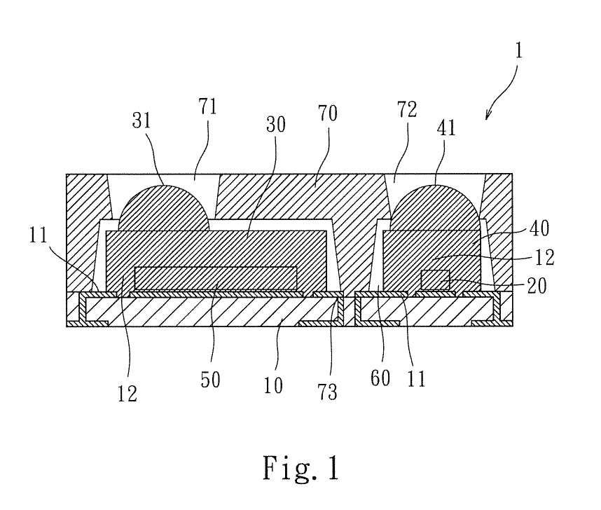

The present invention discloses an optical package module which can be utilized for increasing both the light sensing and emitting efficiency. Please refer to FIG. 1, which shows a schematic drawing of an optical package module in accordance with a first embodiment of the present invention. As shown in FIG. 1, the optical package module 1 of the present invention comprises at least: a substrate 10, a light emitting element 20, a first molding compound 30, a second molding compound 40, a light sensing element 50, and a cap 70. According to one embodiment of the present invention, the light emitting element 20 is disposed on the substrate 10 and forms at least one light emitting area therefore. The light sensing element 50, on the other hand, is disposed on the substrate 10 and forms at lease one light sensing area. The light sensing element 50 may comprise one or more than one sensing integrated chips (IC), and the substrate 10, for example can be a printed circuit board (PCB) or a lead frame. According to one embodiment of the present invention, a plurality of electrical connections 11 are arranged on the substrate 10, such that the light emitting element 20 and the light sensing element 50 can be electrically connected to the electrical connections 11 via at least one wire 12.

According to the first embodiment of the present invention, the first molding compound 30 is formed and molded upon the light sensing element 50. The first molding compound 30 includes a first optical structure 31 which is corresponding to the light sensing element 50. Similarly, the second molding compound 40 is formed and molded upon the light emitting element 20. The second molding compound 40 includes a second optical structure 41 which is corresponding to the light emitting element 20.

As referring to FIG. 1, the cap 70 is molded and fixed to the substrate 10. According to the first embodiment of the present invention, the cap 70 may comprise a light sensing aperture 71, which is corresponding to the first optical structure 31, and a light emitting aperture 72, which is corresponding to the second optical structure 41. A gap 60 is formed between the first molding compound 30 and the second molding compound 40. The cap 70 further comprises a protruding part 73 which extends into the gap 60 so as to separate the light emitting element 20 and the light sensing element 50.

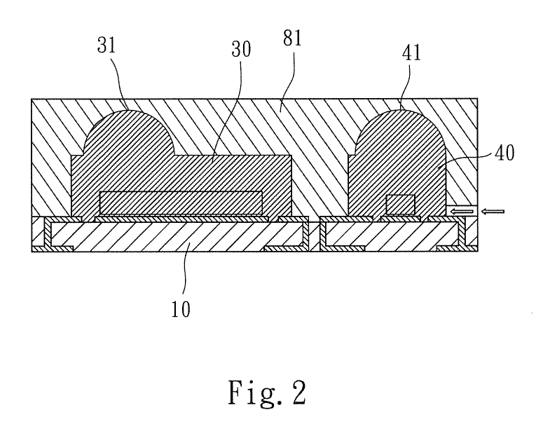

Please refer to FIG. 2 for further description. While in real process, the present invention provides a tooling die 81 for performing molding process such that the first molding compound 30 and the second molding compound 40 can be formed and molded upon the light sensing element 50 and the light emitting element 20, respectively. In one embodiment, the first molding compound 30 and the second molding compound 40 can be made of transparent material, such as transparent Epoxide Resin. Similarly, the cap 70 can also be formed and molded by another tooling die (not shown) and the cap 70, on the other hand, is made of opaque material, such as opaque Epoxide Resin so that light can not get through.

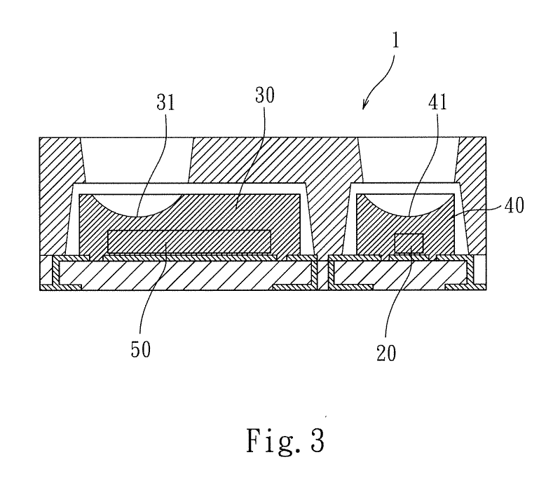

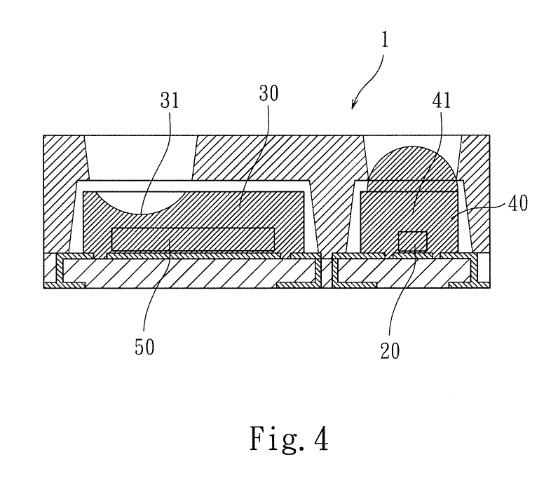

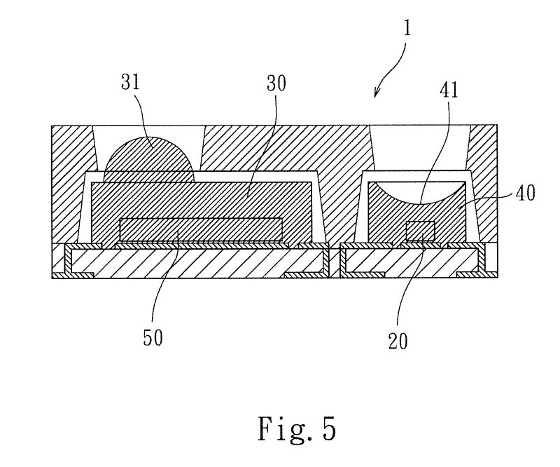

According to the first embodiment of the present invention, the first optical structure 31 and the second optical structure 41 may both be convex lens, such that the refraction efficiency of the light emitting element 20 and the light sensing element 50 can be highly increased due to the design of the first optical structure 31 and the second optical structure 41, thereby improving the light emitting and sensing efficiency of the optical package module of the present invention. Alternatively, as shown in the second embodiment in FIG. 3, the first optical structure 31 and the second optical structure 41 may also be both concave lens, or the first optical structure 31 is a concave lens while the second optical structure 41 is a convex lens as shown in the third embodiment in FIG. 4. Furthermore, according to the fourth embodiment which is FIG. 5 of the present invention, the first optical structure 31 may be designed to be a convex lens while the second optical structure 41 is designed to be a concave lens, which can also be used to implement the objectives of the present invention.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An optical package module, comprising:
a substrate;
a light sensing element disposed on said substrate for forming at least one light sensing area;
a first molding compound, which is molded upon said light sensing element and comprises a first optical structure corresponding to said light sensing element;
a light emitting element disposed on said substrate for forming at least one light emitting area;
a second molding compound, which is molded upon said light emitting element and comprises a second optical structure corresponding to said light emitting element; and
a cap, being fixed to said substrate and comprising a light sensing aperture corresponding to said first optical structure and a light emitting aperture corresponding to said second optical structure.

2. The optical package module of claim 1, wherein said first optical structure is a convex lens or a concave lens.

3. The optical package module of claim 1, wherein said second optical structure is a convex lens or a concave lens.

4. The optical package module of claim 2, wherein said second optical structure is a convex lens or a concave lens.

5. The optical package module of claim 4, wherein said cap further comprises a protruding part which extends into a gap, and said gap is formed between said first molding compound and said second molding compound.

6. The optical package module of claim 4, wherein said substrate is a printed circuit board (PCB).

7. The optical package module of claim 4, wherein said substrate is a lead frame.

8. The optical package module of claim 4, wherein said first molding compound and said second molding compound are made of transparent material, and said cap is made of opaque material or opaque Epoxide Resin.

9. The optical package module of claim 8, wherein said first molding compound and said second molding compound are transparent Epoxide Resin.

10. The optical package module of claim 4, further comprising a plurality of electrical connections disposed on said substrate such that said light emitting element and said light sensing element are electrically connected to said plurality of electrical connections via at least one wire.
